(19) United States
(12) Patent Application Publication
(10) Pub. No.: US 2006/0267309 A1
(43) Pub. Date: Nov. 30, 2006

(54) Supplementary driving mechanism of the muscle-driven vehicle for accelerated rehabilitation of a paralyzed arm

(76) Inventor: Vladimir Markovic, Ljubljana (SI)

Correspondence Address: THE WATSON INTELLECTUAL PROPERTY GROUP, PLC, 3133 HIGHLAND DRIVE, SUITE 200, HUDSONVILLE, MI, 49426, US

(21) Appl. No.: 10/558,847

(22) PCT Filed: May 30, 2003
(86) PCT No.: PCT/SI03/00018

§ 371 Date: Nov. 30, 2005

(51) Int. Cl. B62M 1/14

(52) U.S. Cl. 280/246; 280/250.1

(57) ABSTRACT

The invention involves a supplementary driving mechanism of the muscle-driven vehicle for accelerated rehabilitation of a paralyzed arm, designed for different categories of handicapped persons, primarily those who due to their inability to walk use a wheelchair and have additional troubles with the force of their hands or whose brain has been injured by stroke or mechanical damage and have one arm paralyzed in part or in whole.

The invention involves a supplementary driving mechanism of the muscle-driven vehicle, in particular of a wheelchair that drives the vehicle by converting single-handle or double-handle forward-backward linear movement of a small stroke handle into the circular movement of the mechanism for converting the linear movement of the handle into continuous circular movement that is transmitted to the driving wheel via a chain, a toothed belt, a vertical axle or of similar transmission element, through a rotary, vertical and centrally fixed element, from the driving handle to the driving wheel. The driving wheel and the converting mechanism are fixed into the rod structure that provides for the start-up of the driving mechanism and for its folding under the seat of the wheelchair when the driving mechanism is not in use. The invention has been classified into class B 62 M I/16 of the international patent classification.

The technical problem successfully solved by the solution in question involves the construction of such mechanism that can be easily fixed to the standard structure of a wheelchair or of a similar chair and that will provide for a more simple and powerful manual driving of the wheelchair as well as for significantly easier handling thereof even in the case of limited space, and for better rehabilitation of an injured or even paralyzed driver's arm.

The manual driving mechanisms of wheelchairs known hitherto are based on the principle of repeated grasping and pushing of the driving rims mounted on the rear pair of bigger wheels. The front pair of small wheels is fixed to the wheelchair structure in the way to allow for rotation. The wheelchair can be manoeuvred by simultaneous pushing the driving rim of one wheel and by pulling the driving wheel of the other wheel. Such manoeuvering requires more effort from the invalids and is practically impossible for those with both upper limbs injured. The speed of the wheelchair depends on individual's power and skill, but usually an invalid cannot drive on greater slopes and cannot cover long distances. An even greater problem arises in case when the invalid can only use one hand, like most of those attacked by stroke, some patients suffering from multiple sclerosis, many invalids with cerebral injuries etc.

The imposed technical problem is successfully solved by a supplementary driving mechanism of the muscle-driven vehicle, such as referred to in this invention, provided on one side of the central driving rotation point with a driving handle and with a part of the driving mechanism mounted on a special tumbling rod structure, while the other part of the mechanism for converting the linear movement into continuous circular movement is mounted on the other side. The driving force is transmitted via transmission elements, e.g.: chains and chain pairs, toothed belts and pulleys, steel twisted cables and winding discs, axles and angular gear pairs, or via a similar transmission element, through a central driving rotation point and vertically to the driving wheel. The entire structure is detachably mounted to the wheelchair frame, while the tumbling rod structure allows for activation and de-activation of the supplementary driving mechanism of the muscle-driven vehicle and its folding under the seat of the wheelchair.

In addition to the above described features, the structure of the supplementary driving mechanism referred to in this invention successfully solves the technical problem of such driving mechanism that would—without any major technical changes or interventions—allow for single-hand double-hand driving by a large number invalids with very little force in their upper limbs.

Moreover, the device referred to in this invention is very important as a rehabilitation facility, in particular for invalids attacked by stroke, because in addition to the general exercising of muscles on the paralyzed arm, performed by the healthy arm on the paralyzed arm during the driving operation, it for the first time involves synchronous combining of the non-injured and injured cerebral hemispheres through reverse and/or passive electric pulses, arising from both arms simultaneously and motorically synchronized, which opens completely new possibilities for faster and much more efficient rehabilitation of the injured cerebral hemisphere.

The invention will be explained in detail on the basis of two concrete examples of driving handles and three concrete examples of the driving mechanism, shown in the figures as follows:

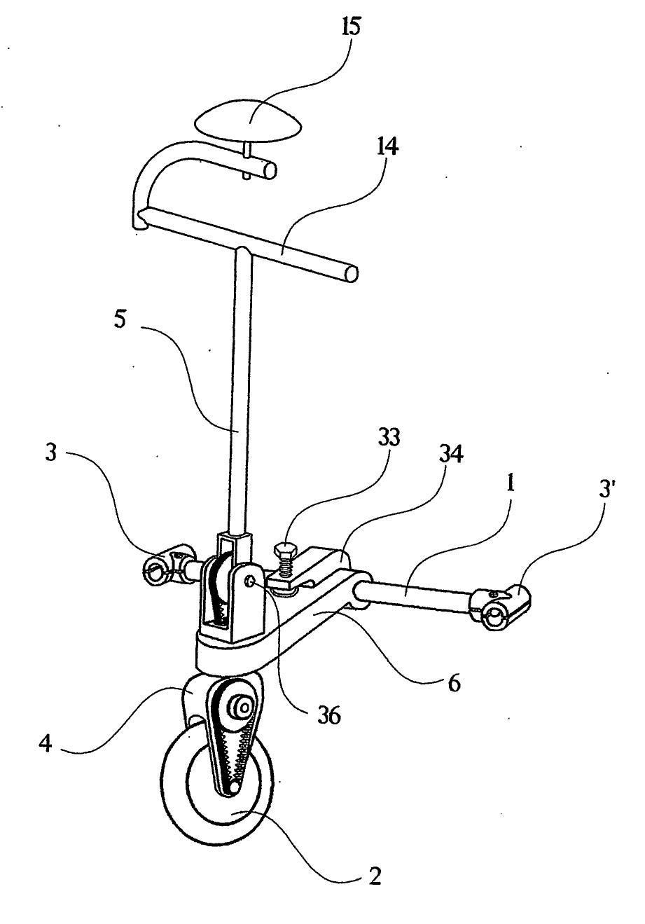

FIG. 1 shows an axionometric view of the supplementary driving mechanism of the muscle-driven vehicle referred to in this invention, with reference to the first concrete example;

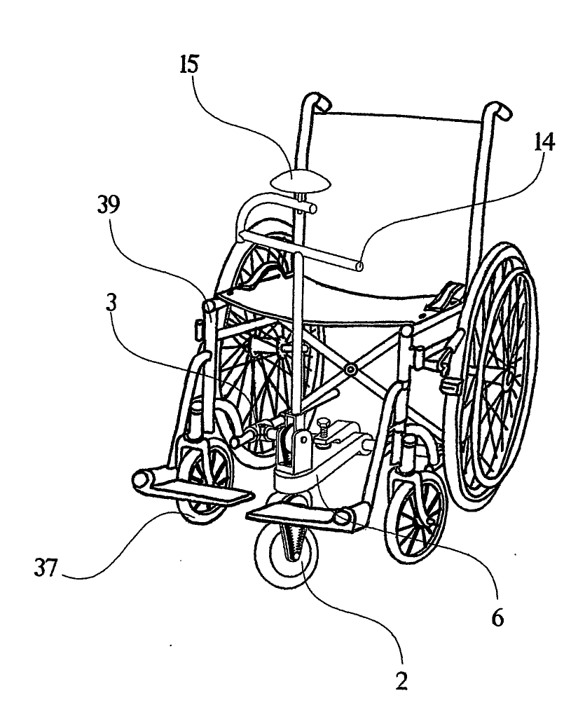

FIG. 2 shows an axionometric view of the supplementary driving mechanism of the muscle-driven vehicle referred to in this invention, with reference to the first concrete example mounted on the wheelchair;

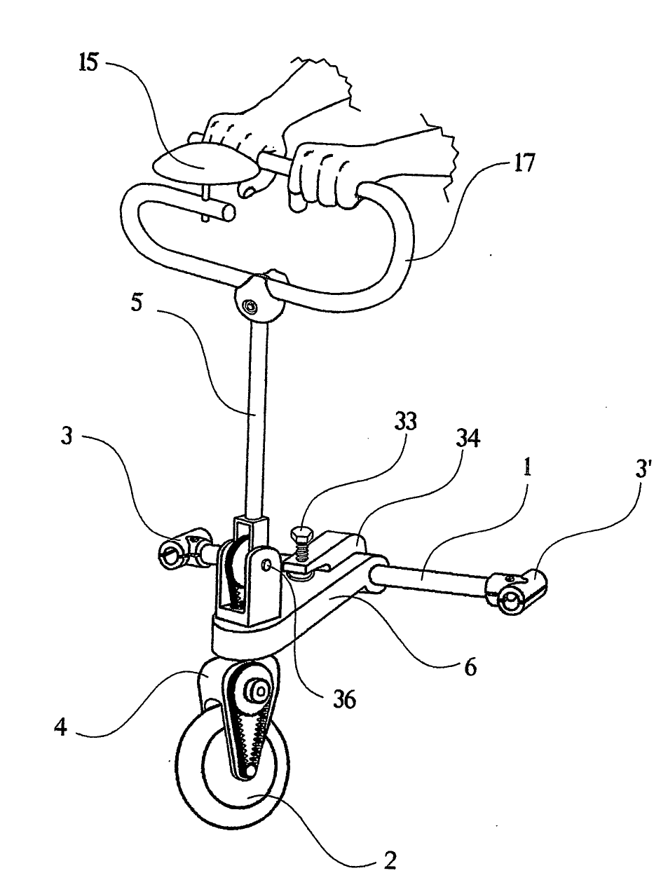

FIG. 3 shows an axionometric view of the supplementary driving mechanism of the muscle-driven vehicle referred to in this invention, with reference to the second concrete example of the driving handle driven by both hands;

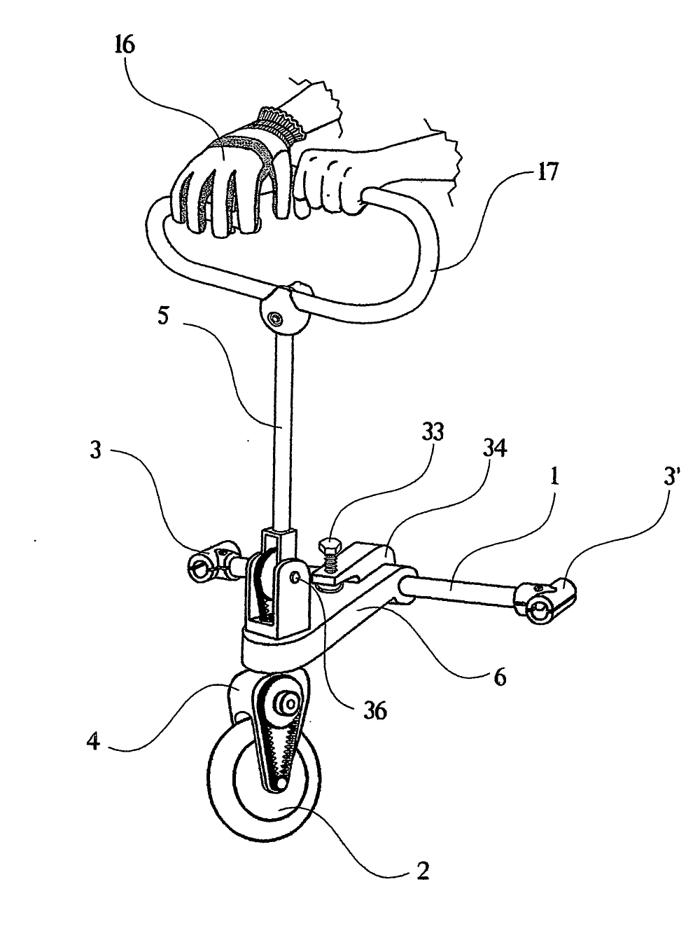

FIG. 4 shows an axionometric view of the supplementary driving mechanism of the muscle-driven vehicle referred to in this invention, with reference to the second concrete example of the driving handle, including partial view of both driver's arms, where the healthy arm performs the driving operation, while the paralyzed arm is fixed above the healthy arm with a particular glove;

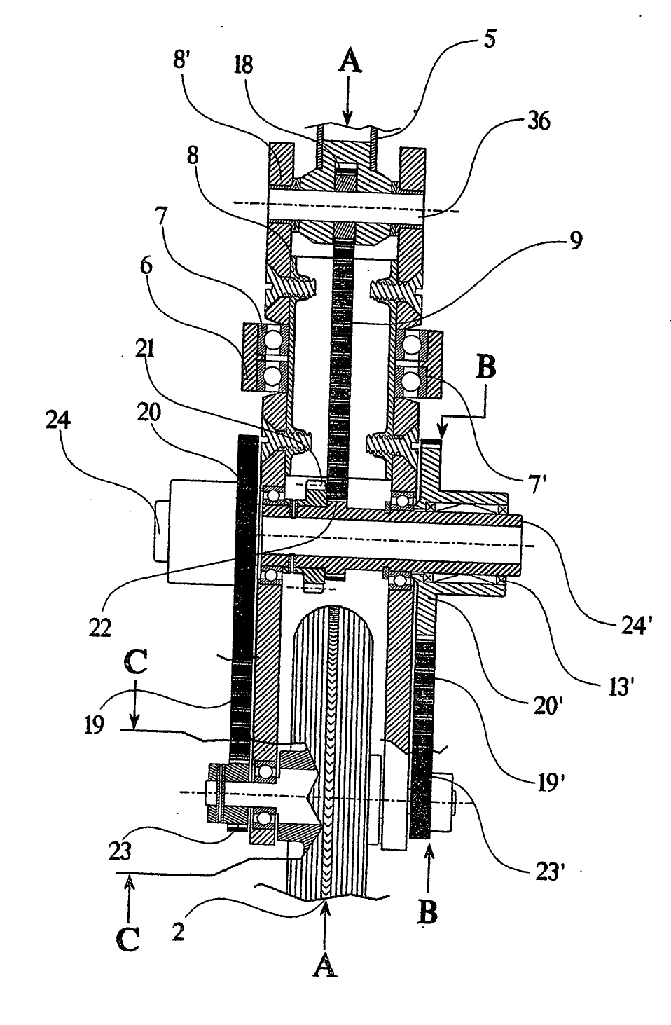

FIG. 5 shows the front cross-section of the supplementary driving mechanism of the muscle-driven vehicle referred to in this invention, with reference to the first concrete example with transmission elements in the form of toothed belts;

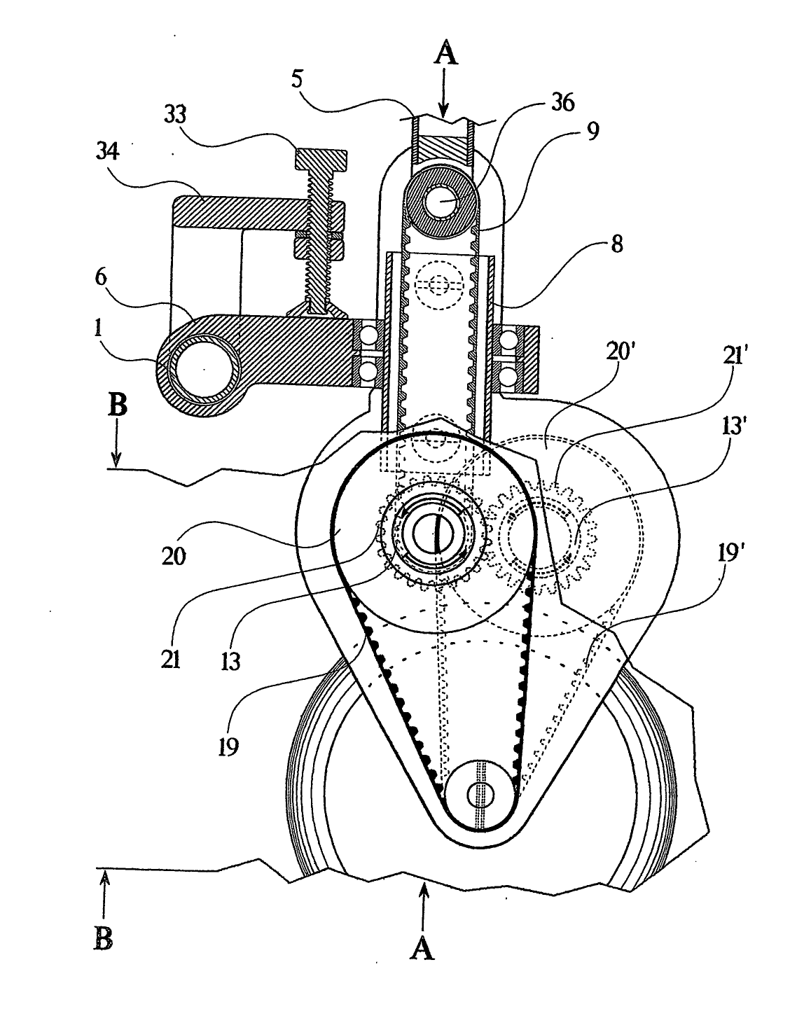

FIG. 6 shows the lateral cross-section on the right hand side of the supplementary driving mechanism of the muscle-driven vehicle referred to in this invention, with reference to the first concrete example with transmission elements in the form of toothed belts;

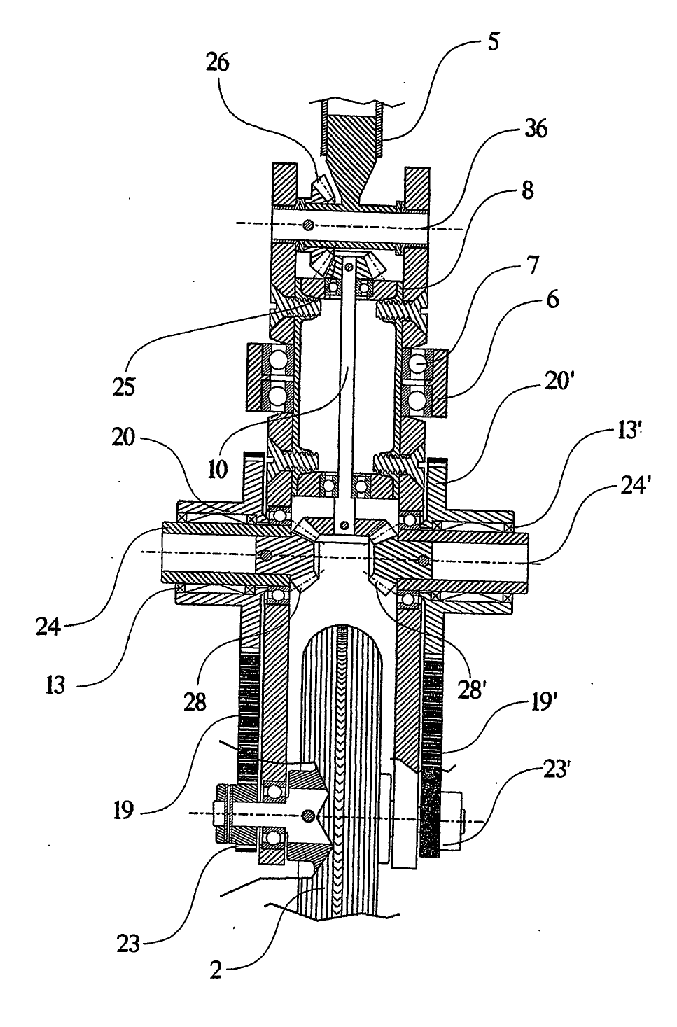

FIG. 7 shows the front cross-section of the supplementary driving mechanism of the muscle-driven vehicle referred to in this invention, with reference to the second concrete example with transmission elements in the form of transmission axles and angular gear pairs;

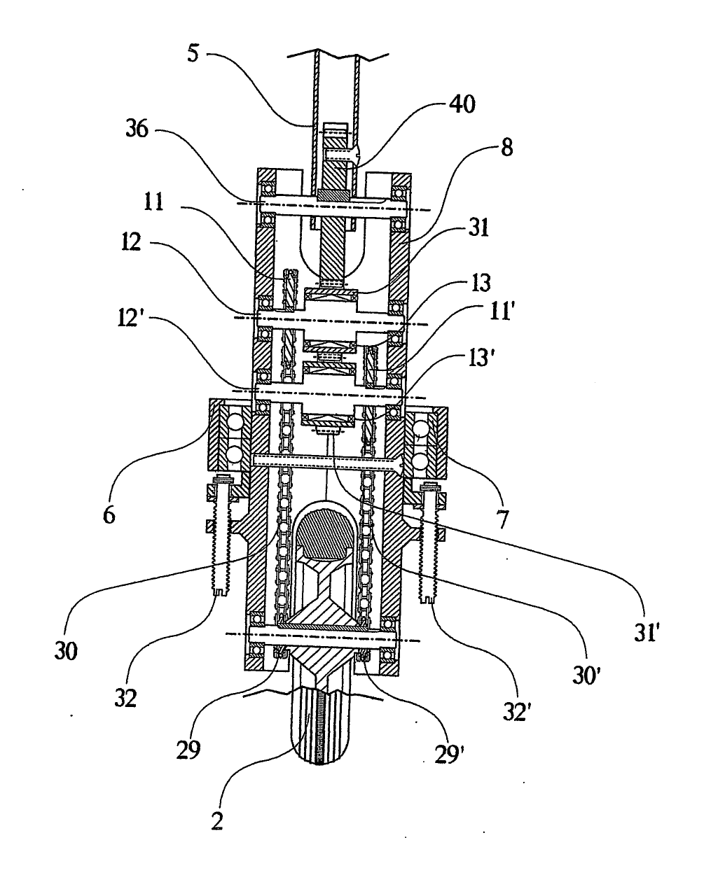

FIG. 8 shows the front cross-section of the supplementary driving mechanism of the muscle-driven vehicle referred to in this invention, with reference to the third concrete example with transmission elements in the form of chains and chain wheels;

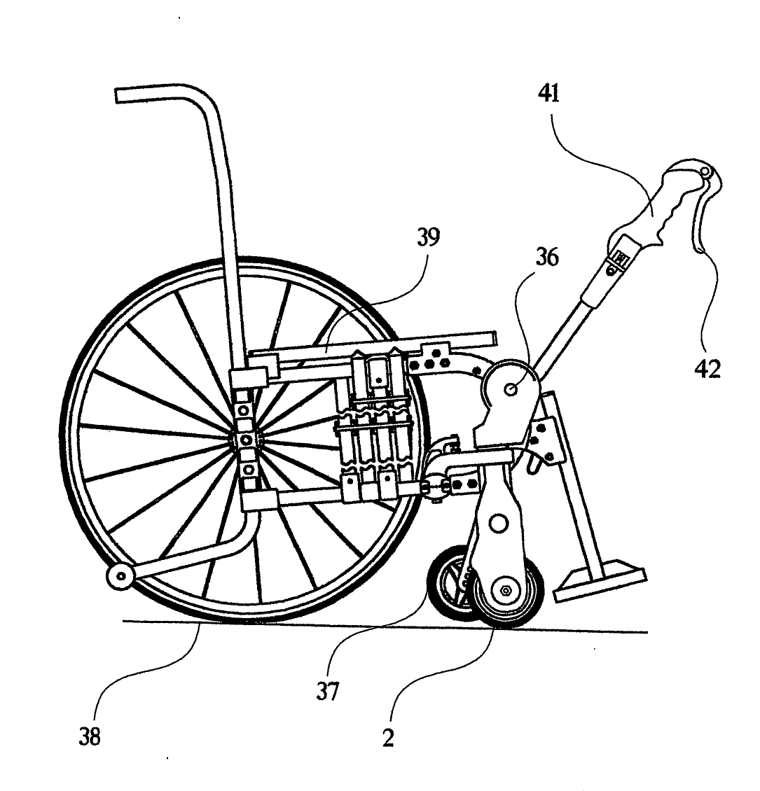

FIG. 9 shows the technical drawing—the cross-section of the wheelchair with mounted supplementary driving mechanism of the muscle-driven vehicle referred to in this invention, in the operating position;

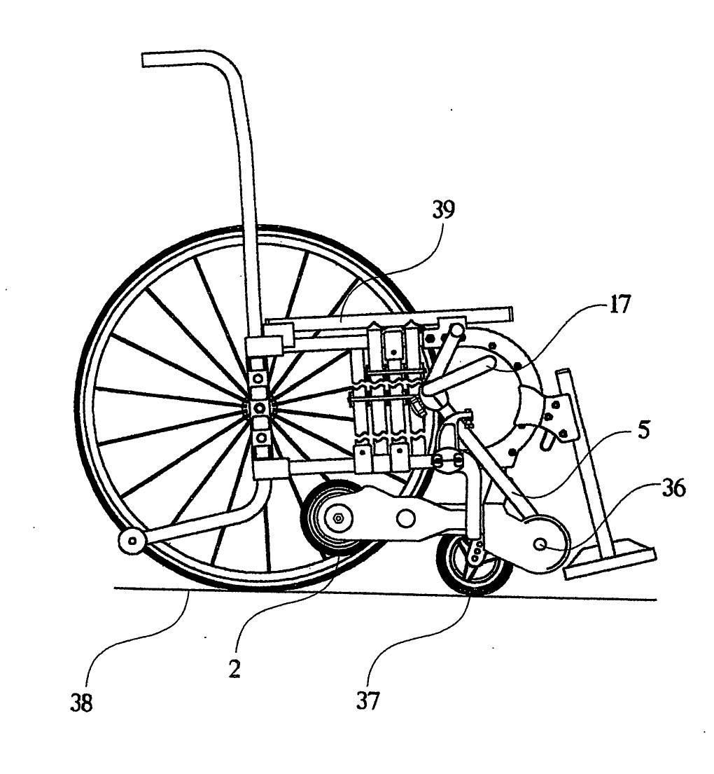

FIG. 10 shows the technical drawing—the cross-section of the wheelchair with mounted supplementary driving mechanism of the muscle-driven vehicle referred to in this invention, in the folded position.

The supplementary driving mechanism of the muscle-driven vehicle referred to in this invention, such as shown in FIG. 1, consists of carrier elements 1, the driving wheel 2 and the driving mechanism 4 for converting the oscillating movement of the driving & steering lever 5 to continuous circular movement of the driving wheel 2. The main carrier 6 is provided at the front with a built-in pair of ball bearings 7, 7′ with a mounted hollow rotary vertical steering axle 8 with mounted transmission elements 9, 10, 30, 30′ that serve for transmission of the driving force from the driving & steering lever 5 to the driving wheel 2.

The transversal carrier 1 bears a mounted main carrier 6 whereof the rotation is limited by the angular carrier 34 that bears the adjustment screw 33. The whole mechanism 4 converting the oscillating movement of the driving lever 5 into continuous rotation of the driving wheel 2 is located at the front part of the carrier 6, which during the driving operation allows for free and simultaneous horizontal rotation of the driving & steering lever 5 and of the driving wheel 2 as well as for simultaneous steering of the wheelchair. Besides, the screw 33 is designed for pre-setting the vertical angle of the whole driving mechanism structure, such as referred to in this invention, in its operating and/or driving position.

In all three concrete examples of the driving mechanism referred to in this invention, the driving mechanism is provided with at least two built-in rotary one-directional rotation blocking elements 13, 13′, preferably by the German manufacturer INA, model HFL 2026, with their one-directional blocking effect providing for conversion of the two-directional oscillating movement of the driving & steering lever 5 that coincides with the one-directional driving of the driving wheel 2 exclusively in the direction of driving.

FIGS. 1 and 2 show the first concrete example of the driving handle 14 on the driving mechanism and the respective mounting position on a standard wheelchair. FIGS. 3 and 4 show the second concrete example of the driving handle 17. In both examples of different driving handles 14, 17, their extensions serve for mounting an additional, freely rotating, semi-circular support 15, intended for optional mounting of the glove 16 where the patient recovering from stroke can put and fix his paralyzed hand in order to exercise his paralyzed arm during the driving operation performed by his healthy arm. The driving handles 14, 17 can also assume some different and/or optional shape 41, whereby the rotary, semi-circular support 15 always has to be fixed at a mechanical point of the driving lever 5 that lies above the point where the driving & steering operation is performed by the driver's healthy arm.

FIGS. 5, 6 show the first concrete example of the driving mechanism referred to in this invention where the driving force is transmitted from the driving lever 5 to the driving lever 2 via toothed belts 9, 19, 19′ and toothed pulleys 18, 20, 20′, 23, 23′. Between axles 24, 24′ and pulleys 20, 20′, there are mounted one-directional rotation blocking elements that due to the counter-rotating gear pair 21, 21′ secure permanent driving direction of the driving wheel 2 irrespective of the movement direction of the driving lever 5.

FIG. 7 shows the second concrete example of the driving mechanism referred to in this invention, where the driving force is transmitted from the driving lever 5 to the driving lever 2 via gear pairs of angular gears 25, 26, 27, 28, 28′, axle 10, pulleys 20, 20′, 23, 23′ and toothed belts 19, 19′. The one-directional rotation blocking elements 13, 13′ are mounted in the pulley 20, 20′. Differently from the first concrete example, in the second example the axes 24, 24′ are mounted in the way that their lines lie on the same axis, instead of the flat gears 21, 21′ from the first example, they bear angular gears 28, 28′. Between axes 24, 24′ and pulleys 20, 20′, there are mounted one-directional rotation blocking elements 13, 13′ that due to the counter-rotating gear pair 28, 28′ secure permanent driving direction of the driving wheel 2 irrespective of the movement direction of the driving lever 5.

FIG. 8 shows the third concrete example of the driving mechanism referred to in this invention, where chains 30, 30′ and chain wheels 11, 11′, 29, 29′ are used as transmission elements. In the driving rotation point of the driving lever 5 there is mounted the gear 40 that in its grip fits to the gear 31, locted opposite to the gear 31′. Inside the gears 31, 31′, there are mounted one-directional rotation blocking elements 13, 13′ with axles 12, 12′ that bear the chain wheels 11, 11′. When driving takes place on the driving lever 5, the oscillating rotation forwards-backwards of the gear 40 constantly turns the gear 31 counterclockwise and the gear 31 in the same direction as the gear 40. Due to the one-directional rotation blocking elements 13, 13′, the active driving power is transmitted to the driving wheel 2 on pushing the driving lever 5 via the chain 30 and on pulling the driving lever 5 via the chain 30′. The above concrete example also includes the adjustment screws 32, 32′ for additional adjustment of the distance of the driving mechanism from the ground with reference to the carrier 6.

FIG. 9 shows the cross-section of the wheelchair 39 with the mounted driving mechanism referred to in this invention, of any concrete example, covered with decorative covers and assuming the driving position. In the driving position of the driving mechanism, both front steering wheels 37, 37′ of the wheelchair 39 are by 5 to 15 mm above the ground 38 and the whole structure of the wheelchair and of the driving mechanism referred to in this invention forms a typical three-wheel vehicle with the driving mechanism on the front wheel 2.

FIG. 10 shows the cross-section of the wheelchair 39 with the mounted driving mechanism referred to in this invention, with the driving handle 17, folded under the seat of the wheelchair.

The above described driving mechanism may also be constructed with other known transmission elements connecting the driving lever 5 and the driving wheel 2, such as: toothed belts and pulleys, steel or plastic cords, direct gear links, lever links or other known power or torque transmission elements.

All concrete examples of the above described driving mechanisms are also suitable for mounting the known types of handbrakes 42, similar to bicycle handbrakes, where the brake lever is mounted on the driving handle 14, 17, 41 and the friction brake on the driving wheel 2, whereby the brake twisted wire or other transmission element is mounted in the way that both braking elements are connected by the tube 8.

1. The supplementary driving mechanism of the muscle-driven vehicle for accelerated rehabilitation of a paralyzed arm,
characterized in that the whole driving force generated at pushing and pulling of the driving lever (5) is transmitted to the driving wheel (2) in the centre of the hollow axle (8) and the bearing system (7, 7′) of the vertical mechanical rotating element of the entire driving mechanism, steering the driving direction.

2. The supplementary driving mechanism of the muscle-driven vehicle for accelerated rehabilitation of a paralyzed arm, according to claim 1,
characterized in that when driving forwards, the driving wheel (2) is mounted in front of the horizontal axle of the front mobile wheels (37) of the wheelchair.

3. The supplementary driving mechanism of the muscle-driven vehicle for accelerated rehabilitation of a paralyzed arm,
characterized in that on top of the driving & steering lever (5) there is mounted a driving handle of optional shape (14, 17, 41) for the healthy driver's hand above which there is mounted the mechanical fixing point of the rotary fixing element of the semi-circular or optionally shaped support (15) for the paralyzed driver's arm.

4. The supplementary driving mechanism of the muscle-driven vehicle for accelerated rehabilitation of a paralyzed arm,
characterized in that the whole driving mechanism referred to in this invention can be turned forward and folded under the seat of the wheelchair, whereby the driving & steering lever (5) is turned backwards, while the steering handle (14, 17, 41) may be folded and fixed in appropriate position.
